(19) United States
(12) Patent Application Publication
(10) Pub. No.: US 2020/0073292 A1
(43) Pub. Date: Mar. 5, 2020

(54) IMAGE HEATING APPARATUS

(71) Applicant: CANON KABUSHIKI KAISHA, Tokyo (JP)

(72) Inventors: Ryuhei Ogawa, Kashiwa-shi (JP); Hiroshi Miyamoto, Kawaguchi-shi (JP)

(21) Appl. No.: 16/555,137

(22) Filed: Aug. 29, 2019

(30) Foreign Application Priority Data
Aug. 30, 2018 (JP) 2018-162157

(51) Int. Cl. G03G 15/16; G03G 15/20; B23K 26/067

(52) U.S. Cl. CPC G03G 15/161; G03G 15/2039; G03G 2215/2025; G03G 15/2025; B23K 26/067; G03G 15/2028

(57) ABSTRACT

An image heating apparatus includes a first rotatable member, a second rotatable member, a laser light irradiation portion, and a cleaning member. The cleaning member is provided in a position other than a position where laser light emitted from the laser light irradiation portion toward the nip is blocked.

### FIELD OF THE INVENTION AND RELATED ART

The present invention relates to an image heating apparatus (fixing device) for heating (fixing) a toner image on a recording material with laser light.

In an image forming apparatus such as a copying machine, a printer, a facsimile machine or a multi-function machine having a plurality of functions of these machines, the toner image is formed on the recording material and is fixed on the recording material by a fixing device as an image heating apparatus. As a constitution of the fixing device, a constitution in which the toner image is fixed on the recording material by not only irradiating the toner image with laser light but also pressing the toner image has been proposed (Japanese Laid-Open Patent Application (JP-A) 2017-40770).

The constitution disclosed in JP-A 2017-40770 includes a light source, a contact member rotatable and contactable to the recording material, and an opposite roller which opposes the contact member and which forms a nip in which the recording material is nipped. The contact member permits transmission of laser from the light source and heats, with the laser, the toner image which passes through the nip and which is formed on the recording material.

In the constitution in which the toner image is fixed on the recording material with the laser light as described above, in the case where a lowering in irradiation intensity of the laser light and a change in energy amount due to a lifetime of the light source and the like occur, there is a liability that toner is offset to the contact member. When the toner is offset to the contact member, the offset toner is fixed to the contact member and then the fixed toner is melted again by laser light irradiation during passing thereof through the nip again by rotation of the contact member in some instances. In this case, the toner (toner image) is fixed at an unintended position on the recording material and causes an image defect.

### SUMMARY OF THE INVENTION

A principal object of the present invention is to provide an image heating apparatus capable of suppressing an occurrence of an image defect even when toner is offset to a contact member.

According to an aspect of the present invention, there is provided an image heating apparatus for heating an image on a recording material with laser light, the image heating apparatus comprising: a first rotatable member through which the laser light passes and which is contactable to the image on the recording material; a second rotatable member pressing the first rotatable member to form a nip in which the recording material is nipped and fed; a laser light irradiation portion provided outside the first rotatable member and configured to irradiate the nip with the laser light by emitting the laser light so as to enter the first rotatable member from the outside of the first rotatable member; and a cleaning member configured to clean the first rotatable member in contact with a surface of the first rotatable member, wherein the cleaning member is provided in a position other than a position where the laser light emitted from the laser light irradiation portion toward the nip is blocked.

According to the present invention, even when the toner is offset to the contact member, it is possible to suppress the occurrence of the image defect.

Further features of the present invention will become apparent from the following description of exemplary embodiments with reference to the attached drawings.

### BRIEF DESCRIPTION OF THE DRAWINGS

FIG. 1 is a schematic structural sectional view of an image forming apparatus in First Embodiment.

FIG. 2 is a schematic view of a fixing device according to First Embodiment.

FIG. 3 is a schematic view showing another example of the fixing device according to First Embodiment.

FIG. 4 is a table showing a relationship between a blocking area ratio and necessary irradiation intensity.

FIG. 5 is a schematic view of a fixing device according to Second Embodiment.

FIG. 6 is a table showing a durability of a contact member and toner removal accuracy with respect to a kind of a cleaning member.

FIG. 7 is a schematic view of a fixing according to Third Embodiment.

### DESCRIPTION OF EMBODIMENTS

### First Embodiment

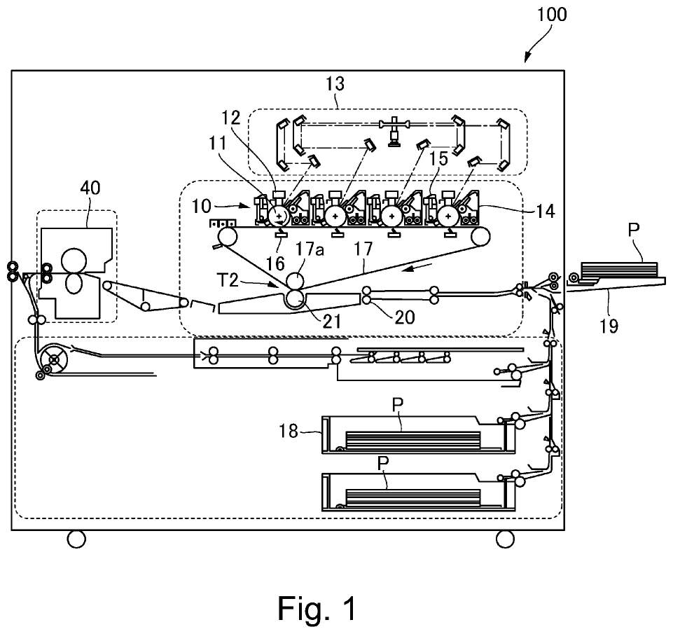

First Embodiment of the present invention will be described with reference to FIGS. 1 to 4. First, a schematic structure of an image forming apparatus in this embodiment will be described with reference to FIG. 1.

### [Image Forming Apparatus]

An image forming apparatus 100 in this embodiment is a full-color printer using an electrophotographic process, and FIG. 1 is a sectional view of the image forming apparatus 100 along a feeding direction of a recording material P. The image forming apparatus 100 forms a toner image (image) on the recording material P depending on an image information signal from an original reading device (not shown) connected to an image forming apparatus main assembly or from a host device such as a personal computer communicatably connected to the image forming apparatus main assembly. As the recording material, it is possible to cite a sheet material such as paper, a plastic film, fabric, or the like.

The image forming apparatus 100 includes image forming portions 10 for respective colors of Y (yellow), M (magenta), C (cyan) and Bk (black). At each of the image forming portions 10, a cylindrical photosensitive member as the image bearing member, i.e., a photosensitive drum 11 is provided. The photosensitive drum 11 is rotationally driven in an arrow direction in FIG. 1. Around the photosensitive drum 11, a charger (charging device) 12, a developing device 14, a primary transfer blade (primary transfer member) 16, and a cleaning device 15. Above the photosensitive drum 11 in FIG. 1, a laser scanner (expose device) 13 is provided.

Further, an intermediary transfer belt 17 as an intermediary transfer member is provided opposed to the photosensitive drum 11 of each of the image forming portions 10 for the respective colors. The intermediary transfer belt 17 is stretched by a plurality of stretching rollers, and is circulated moved by a driving roller of the stretching rollers in the direction indicated by an arrow in FIG. 1. Incidentally, the intermediary transfer belt 17 moves in a counter direction opposite to a movement direction of the photosensitive drum 11 at a contact position where the intermediary transfer belt 17 contacts the photosensitive drum 11. However, the image forming portion 10 may also be constituted so that the contact position, the movement directions of the intermediary transfer belt 17 and the photosensitive drum 11 are the same direction (normal direction).

At a position opposing an inner secondary transfer roller 17a of the plurality of stretching rollers via the intermediary transfer belt 17, an outer secondary transfer roller 21 is provided and constitutes a secondary transfer portion T2 where the toner images are transferred from the intermediary transfer belt 17 onto the recording material P. At a position downstream of the secondary transfer portion T2 with respect to a recording material feeding direction, a fixing device 40 as an image heating apparatus is provided.

The photosensitive drum 11 is electrically charged by the charger 12. Thereafter, on a surface the photosensitive drum 11, by the laser scanner 13, an electrostatic latent image depending on an image signal is formed. The electrostatic latent image formed on the photosensitive drum 11 is developed into a toner image with toner by the developing device 14. The toner image on the photosensitive drum 11 is transferred onto the intermediary transfer belt 17 by the primary transfer blade 16. After the transfer, the toner remaining on the surface of the photosensitive drum 11 is removed by the cleaning device 15. As a result, the surface of the photosensitive drum 11 is cleaned and prepares for subsequent image formation.

Such an operation is successively performed at the respective image forming portions, so that the four color toner images are superposed on the intermediary transfer belt 17.

On the other hand, the recording material P is fed one by one from a feeding cassette 18 or a feeding tray 19 and then is conveyed to a registration roller pair 20. The registration roller pair 20 once receives the recording material P and corrects the recording material P straight in the case where the recording material P moves obliquely. Then, the registration roller pair 20 achieves synchronization between the recording material P and the toner images on the intermediary transfer belt 17 and then sends the recording material P to the secondary transfer portion T2. The color toner images on the intermediary transfer belt 17 are transferred onto the recording material P at the secondary transfer portion T2. Thereafter, the toner images on the recording material P is heated and pressed in the fixing device 40 and thus is fixed on the recording material P.

### [Fixing Device]

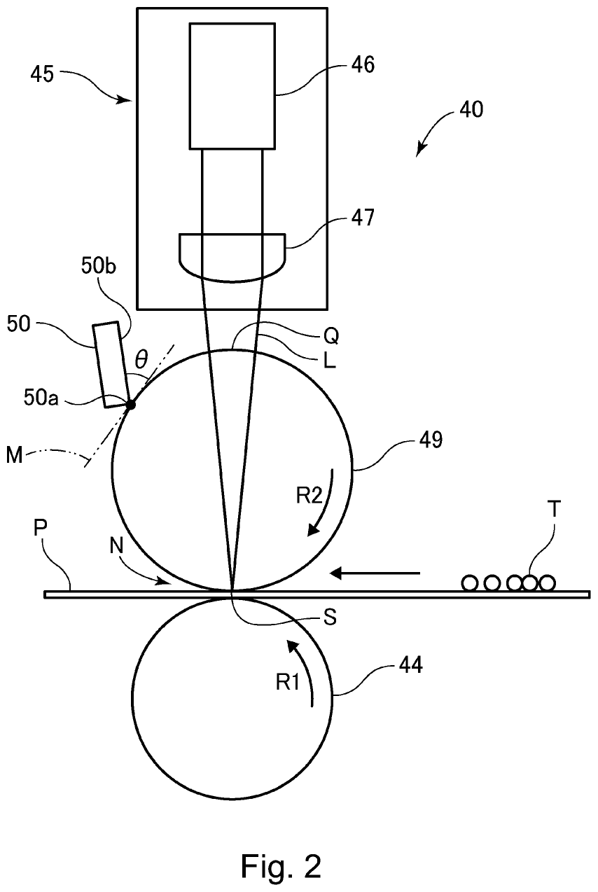

Next, the fixing device 40 of this embodiment will be described with reference to FIG. 2. The fixing device 40 fixes the toner images on the recording material P by using laser light and includes a laser light irradiation portion 45, a contact member 49, an opposite roller 44 as a nip forming member, and a blade 50 as a cleaning member.

The laser light irradiation portion 45 is arranged in a plurality of positions along a longitudinal direction of the fixing device 40. The longitudinal direction is perpendicular to the drawing sheet of FIG. 2 and is parallel to a widthwise direction crossing (in this embodiment, substantially perpendicular to) the feeding direction of the recording material P. The laser light irradiation portion 45 includes a laser array 46 in which a plurality of laser light sources (not shown) are arranged along the longitudinal direction and includes a collimating lens 47 for changing laser emitted from each of the laser light sources to parallel laser and enabling condensation of laser. The collimating lens 47 is disposed in a casing of the laser light irradiation portion 45. As the laser light source, it is possible to cite a light source including a laser element such as a gas laser.

Such a laser light irradiation portion 45 irradiates the contact member 49 described later with laser light L. Further, the laser light irradiation portion 45 is disposed on a side (in this embodiment, above the contact member 49) opposite from the nip while sandwiching the contact member 49 between itself and the nip. Further, the laser light irradiation portion 45 emits the laser light so as to enter a part (upper portion) of the surface of the contact member 49.

The contact member 49 contacts the recording material P at a contact position S while rotating and permits transmission of the laser emitted from the laser light irradiation portion 45 and guides the laser to the contact position S. In this embodiment, the contact member 49 is a cylindrical optical member, specifically a lens. Such a contact member 49 may only be required to permit transmission of the laser light and may preferably have higher transmittance from the viewpoint of efficiency. In this embodiment, the contact member 49 is constituted by a cylindrical glass on which outer peripheral surface a transparent rubber layer and a layer of a fluorine-containing resin material such as PFA (tetrafluoroethylene-perfluoroalkylvinyl ether copolymer) are formed.

The contact member 49 concentrates the laser light L, emitted from the laser light irradiation portion 45, at a nip N formed at the contact position S between itself and the opposite roller 44 described later. The position where the laser light is concentrated is, for example, a central portion of the nip N with respect to the feeding direction of the recording material P. As a result, irradiation energy necessary to fix the toner images on the recording material P fed to the nip N is obtained. Incidentally, for example, the contact member 49 may also employ a constitution in which an endless transparent member sliding on the lens member is used.

The opposite roller 44 is disposed so as to oppose the contact member 49 and forms the nip N in which the recording material P is nipped between itself and the contact member 49. Such an opposite roller 44 is formed of stainless steel in a cylindrical shape and forms the nip N between itself and the contact member 49 in contact with the contact member 49. The opposite roller 44 and the contact member 49 are disposed so that rotational axis directions are substantially parallel to each other.

Further, the opposite roller 44 is urged toward the contact member 49 by an unshown urging member such as a spring, for example, so that a predetermined pressure (pressing force) acts between the opposite roller 44 and the contact member 49. The predetermined pressure by the opposite roller 44 may preferably be a pressure capable of providing a sufficient fixing property in consideration of a relationship with heating energy by the laser light.

The opposite roller 44 is rotationally driven in an arrow R1 direction via a gear by an unshown motor, so that the contact member 49 is rotated in an arrow R2 direction by the opposite roller 44. Incidentally, the opposite roller 44 and the contact member 49 may also be driven by separate driving source. In this way, the opposite roller 44 and the contact member 49 are rotated, whereby the recording material P is fed through the nip N while being nipped.

In the thus-constituted fixing device 40, during nip-feeding of the recording material P in the nip N, the nip N is irradiated with the laser light by the laser light irradiation portion 45. The laser light enters from an incident position Q at the upper portion of the surface of the contact member 49 and passes through the contact member 49, and is concentrated at the nip N. As a result, the toner image on the recording material P fed in the nip N is irradiated with the laser light, so that the toner image is heated. At this time, the recording material P is pressed in the nip N, and therefore, the toner image is heated and pressed in the nip N and thus is fixed on the recording material P.

Thus, the toner image on the recording material P is simultaneously subjected to the laser light irradiation and the pressure application and thus is fixed on the recording material P, so that irradiation energy necessary for the laser light can be reduced compared with a constitution in which the toner image is fixed on the recording material by being irradiated with the laser light without pressing the recording material. Further, by pressing the recording material P, the surface of the toner (toner image) T on the recording material is smoothed, so that the toner image with high glossiness is formed.

Incidentally, the laser light irradiation portion 45 turns on output of the laser light in synchronism with timing when the fed recording material P reaches the nip N. As an example, a movement time is measured from a time when the recording material P is fed from the feeding cassette 18. Then, after a lapse of a predetermined time, the output of the laser light is turned on. The fixing device 40 according to this embodiment is, different from a constitution in which the toner image is heated by a fixing device in which a heater is provided, not required to heat the fixing roller through residual heat, so that the laser light irradiation may only be required to be performed immediately before the recording material P enters the nip N. However, in consideration of responsiveness of the laser or the like, a margin may preferably be appropriately provided.

After the recording material p passes through the nip N, an image forming operation is ended, and at the time when there is no subsequent image formation instruction, the output of the laser light is turned off Incidentally, a constitution in which the output of the laser light is turned off after the recording material P passes through the nip N, and then is turned on again at timing when a subsequent recording material P reaches the nip N.

### [Cleaning Member]

Next, the blade 50 as a cleaning member for cleaning the surface of the contact member 49 will be described. As described above, in the case where the lowering in laser light irradiation intensity and the change in energy amount due to the laser or the like of the light source occur, the toner T is offset to the contact member 49 in some instances. When the toner T is offset to the contact member 49, the offset toner is fixed on the contact member 49. When the fixed toner passes through the nip N again by rotation of the contact member 49, the toner is melted again by being irradiated with the laser light L in some instances. In this case, the toner (toner image) is fixed at an unintended position on the recording material P, so that the image defect is caused to occur.

For this reason, in this embodiment, the surface of the contact member 49 is cleaned by the blade 50. That is, the offset toner deposited on the contact member 49 is scraped off by the blade 50. The blade 50 is provided in a position of the surface of the contact member 49 where the laser emitted from the laser light irradiation portion 45 is not blocked, and cleans the surface of the contact member 49. Such a blade 50 is a substantially rectangular plate-like member extending along a longitudinal direction (rotational axis direction) of the contact member 49, and a free end thereof contacts the contact member 49. The blade 50 is disposed in a counter direction to the rotational direction (arrow 22 direction) of the contact member 49. The counter direction refers to a direction in which a direction of a free end portion of the blade 50 which contacts the contact member 49 and which extends is opposite to a tangential direction along the rotational direction of the contact member 49.

In this embodiment, a portion where the blade 50 and the contact member 49 contact each other is a contact portion 50a, and a side surface which is on a side downstream of the contact portion 50a with respect to the rotational direction of the contact member 49 and on the contact member 49 side surface 50b. Further, a tangential line of the contact member 49 passing through the contact portion 50a is M. In this case, the blade 50 is disposed so that an angle A formed between the side surface 50b and the tangential line M is less than 90°. In this embodiment, the angle A (contact angle of the blade 50 relative to the surface of the contact member 49) is 15° or more and 35° or less. Here, the contact angle is an average of values obtained by measuring the contact angle at opposite end portions of the blade 50 with respect to a widthwise direction of the blade 50 (i.e., the longitudinal direction of the contact member 49).

Further, the blade 50 is contacted to the surface of the contact member 49 with a pressure (contact pressure) of 12.3 N/m or more and 43 N/m or less. Here, the contact pressure is an average of values obtained by measuring the contact pressure when the blade 50 is divided into five portions with respect to the longitudinal direction and is abutted against a load cell.

The blade 50 is constituted by a plate-like rubber member and a supporting metal plate, and as an example of the rubber member, an urethane rubber of 77° in hardness (JIS-A) and 2.2 mm in thickness is used. The urethane rubber is synthesized using a polyisocyanate, a polyol, a chain extender and an urethane rubber synthesis catalyst, but is not limited thereto. Incidentally, the toner scraped off by the blade 50 is collected in an unshown collecting box provided below the blade 50. Or, the scraped toner drops in an unshown casing in which the blade 50 is provided, and then is fed to the unshown collecting box by a feeding screw, for example.

A position where the blade 50 is disposed may only be required to be a position, with respect to the rotational direction of the contact member 49, where irradiation with the cleaning L is not blocked. The blade 50 may preferably disposed so as to clean the surface of the contact member 49 at a position, with respect to the rotational direction of the contact member 49, downstream of the nip N and upstream of the incident position Q where the laser emitted from the laser light irradiation portion, 45 enters the contact member 49. That is, the blade 50 may preferably be contacted to the contact member 49 at the position downstream of the nip N and upstream of the incident position Q with respect to the rotational direction of the contact member 49. As shown in FIG. 2, the incident position Q of the laser light L has a width with respect to the rotational direction of the contact member 49, but the position where the blade 50 contacts the contact member 49 may preferably be located upstream of an upstream end portion of this width.

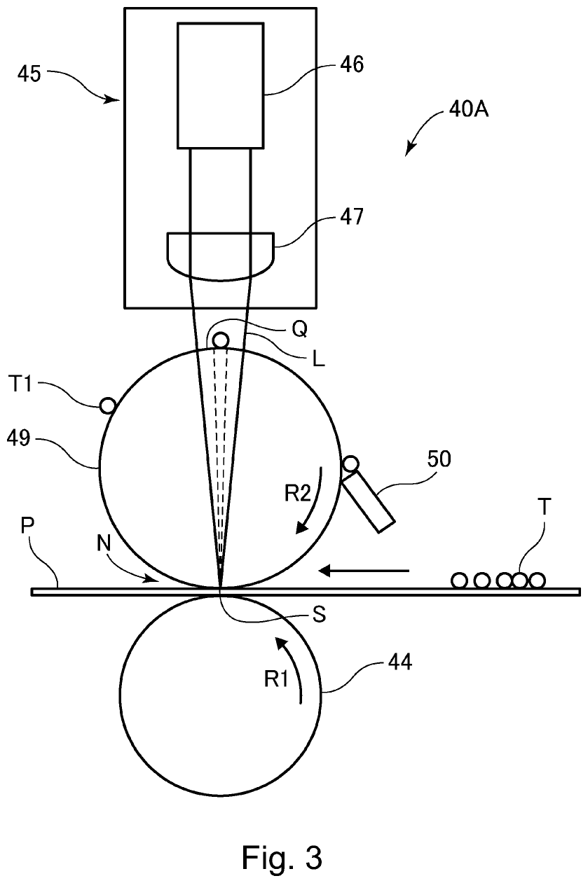

Incidentally, the position where the blade 50 is disposed may also be, as in another example of this embodiment shown in FIG. 3, located upstream of the nip N and downstream of the incident position Q with respect to the rotational direction of the contact member 49. A fixing device 40A has the same constitution as the constitution of the fixing device 40 shown in FIG. 2 except for the position where the blade 50 is disposed. However, for the following reason, the position where the blade 50 is disposed may preferably be located downstream of the nip N and upstream of the incident position Q as shown in FIG. 2.

The reason of this will be described using FIG. 3. In this case the recording material P on which the toner T is placed is fed to the nip N, when energy supplied to the toner by the laser light fluctuates, the toner T is not fixed on the recording material P, and offset toner T1 deposited on the contact member 49 generates.

When the offset toner T1 comes out of the nip N by the rotation of the contact member 49, the offset toner T1 moves with the rotation of the contact member 49 in a cooled and fixed state. Thereafter, the offset toner T1 fixed to the contact member 49 reaches the incident position Q of the laser light L at a top (upper) surface of the contact member 49, and blocks a part or all of the laser light L as shown in FIG. 3. When the laser light L is blocked by the offset toner T1, irradiation intensity of the laser light reaching the nip N is weakened. As a result, there is a liability that the offset toner further generates. For example, in order to obtain a sufficient fixing property in the case where a glossy image is outputted using coated paper, when a feeding speed of the recording material P is 1000 mm/s and an irradiation width of the laser light L with respect to the feeding direction is 50 mm, the laser light irradiation intensity may preferably be 30 W/cm² or more.

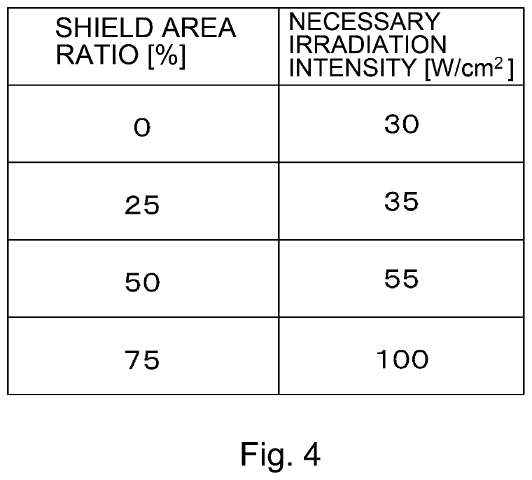

Here, as shown in FIG. 3, in the case where the blade 50 is disposed downstream of the incident position Q of the laser light on the contact member 49, in order to obtain a sufficient fixing property even when the offset toner T1 generates, there is a need to increases the laser light irradiation intensity depending on a block area ratio. The block area ratio is {[offset toner area]/[laser light irradiation region area of incident position Q]}×100. A relationship between the block area ratio and necessary laser light irradiation intensity is shown in FIG. 4. The increase in laser light irradiation intensity leads to an increase in cost and leakage of the laser light.

From the above, the position where the blade 50 is disposed may preferably be located downstream of the nip N and upstream of the incident position Q as shown in FIG. 3. That is, the blade 50 is disposed upstream of the incident position Q of the laser light L on the contact member 49, whereby the offset toner T1 can be collected by the blade 50 before the offset toner T1 reaches the incident position Q of the laser light L. For this reason, the irradiation intensity of the laser light with which the nip N is irradiated can be maintained, so that further generation of the offset toner due to improper fixing can be suppressed.

However, as shown in FIG. 3, also in the case where the blade 50 is disposed downstream of the laser light incident position Q, it is possible to prevent that the offset toner T1 reaches the nip N and is fixed to an unintended position. For that reason, compared with the case where the blade 50 is not disposed, the image defect can be reduced.

As described above, in the case of this embodiment, the blade 50 is provided at a position, of the surface of the contact member 49, where the laser emitted from the laser light irradiation portion 45 is not blocked, and then the surface of the contact member 49 is cleaned by the blade 50. For this reason, even when the toner is offset to the contact member 49, it is possible to suppress that the offset toner is fixed to an unintended place and then the image defect occurs. Particularly, as shown in FIG. 2, with respect to the rotational direction of the contact member 49, the blade 50 is disposed downstream of the nip N and upstream of the incident position Q, so that further generation of the offset toner can be suppressed.

### Second Embodiment

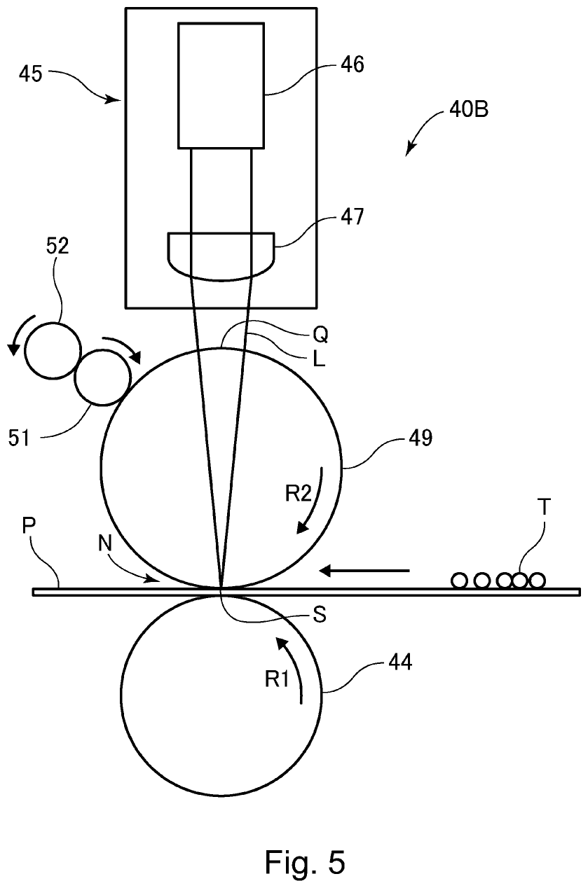

Second Embodiment will be described using FIG. 5. In the case of this embodiment, the cleaning member for cleaning the surface of the contact member 49 is changed from the blade of First Embodiment to a fur brush 51. Other constitutions and actions are similar to those in First Embodiment. For this reason, in the following, constitutions similar to those in First Embodiment will be omitted from description or briefly described by adding the same reference numerals or symbols, and a portion different from First Embodiment will be principally described.

A fixing device 40 of this embodiment includes the fur brush 51 as the cleaning member for cleaning the contact member 49. The fur brush 51 is prepared by planting fibers on an outer peripheral surface of a rotation shaft (core metal), and in this embodiment, the fur brush 51 is prepared by plating fibers, comprising a bundle of filaments made of an acrylic resin material, on the core metal. Further, for example, an outer diameter of an entirety of the fur brush 51 is 20.4 mm, and a length of the brush fibers acquired by subtracting 12 mm corresponding to a diameter of the core metal from the outer diameter is 4.2 mm.

The fur brush 51 is disposed downstream of the nip N and upstream of the laser light incident position Q with respect to the rotational direction of the contact member 49, and is contacted to the contact member 49 with ha penetration depth of 0.5 mm. Incidentally, similarly as the blade 50 shown in FIG. 3, the fur brush 51 may also be disposed upstream of the nip N and downstream of the incident position Q.

The fur brush 51 is rotated so as to move in a direction opposite to the rotational direction of the contact member 49 at the contact portion with the contact member 49. Further, the fur brush 51 is rotated at a peripheral speed which is 110% of a peripheral speed of the contact member 49. That is, the peripheral speed of the fur brush 51 is made faster than the peripheral speed of the contact member 49. As a result, the fur brush 51 is capable of scraping off the offset toner on the contact member 49. The offset toner scraped off is collected in an unshown residual (waste) toner box by a toner feeding member 52.

The toner feeding member 52 is, for example, a screw and scrapes off the toner of the fur brush 51 by being rotated in an arrow direction while being contacted to the fur brush 51 and then feeds the scraped toner to the residual toner box. Incidentally, for example, a constitution in which the toner is scraped off of the fur brush 51 by causing the blade to enter the fur brush 51 and then is fed by the feeding member such as the screw may also be employed.

The fibers of the fur brush 51 are selected in consideration of sliding thereof with the contact member 49 by friction in addition to the offset toner and a collecting property of a contaminant. For example, as the fibers of the fur brush 51, the collecting property of the offset toner is enhanced by using a material liable to have an opposite polarity to the charge polarity of the toner.

Also in such a case of this embodiment, the fur brush 51 is provided at a position, of the surface of the contact member 49, where the laser emitted from the laser light irradiation portion 45 is not blocked, and then the surface of the contact member 49 is cleaned by the fur brush 51. For this reason, it is possible to suppress that the image defect occurs even when the toner is offset to the contact member 49. Further, with respect to the rotational direction of the contact member 49, the fur brush 51 is disposed downstream of the nip N and upstream of the incident position Q, so that further generation of the offset toner can be suppressed.

Incidentally, the cleaning member for cleaning the surface of the contact member 49 may also be an air blowing constitution, a web or the like in addition to the blade 50 in First Embodiment and the fur brush 51 in Second to Embodiment. For example, in the case of the air blowing constitution, a blowing opening connected to an air generating device such as a compressor is disposed in the neighborhood of the surface of the contact member 49 and the air is blown onto the contact member 49 through the blowing opening, so that the offset toner deposited on the surface of the contact member 49 is removed. Further, in the case of the web, the web is contacted to the surface of the contact member 49, so that the offset toner deposited on the surface of the contact member 49 is removed. Then, the web is wound up little by little at predetermined timing. An air blowing position and a web contact position may preferably be located downstream of the nip N and upstream of the incident position Q as shown in FIG. 2, but may also be located upstream of the nip N and downstream of the incident position Q as shown in FIG. 3.

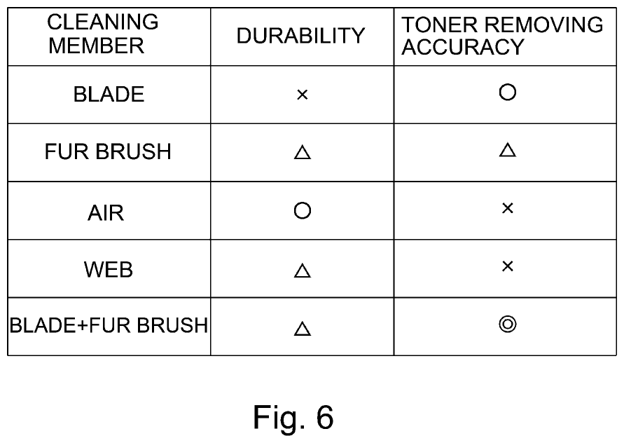

FIG. 6 shows a result of evaluation of durability of the contact member 49 and toner removal accuracy at room temperature in the case where the blade, the fur brush, the air blowing constitution and the web are used as the cleaning member. As is apparent from FIG. 6, the blade 50 can achieve high toner removal accuracy by being abutted against the contact member 49 in a counter direction, while the blade 50 is required to have a high contact pressure and therefore the contact member 49 is abraded and lowers in durability. On the other hand, in the constitution using the fur brush 51, the brush-shaped fibers thereof contact the contact member 49 one by one, not the (planar) surface, and therefore, durability of contact the contact member 49 can be maintained, but correspondingly toner scraping-off power is low.

Further, in the case of the air blowing constitution, the air is blown onto the contact member 49, and therefore, durability of the contact member 49 is good, but toner removing power is low. Further, in the case of the web, a contact area with contact the contact member 49 is larger than a contact area with the blade, and therefore, durability of the contact member 49 is good, but the toner removing power is low. Incidentally, a constitution using the blade and the fur brush will be described in Third Embodiment.

### Third Embodiment

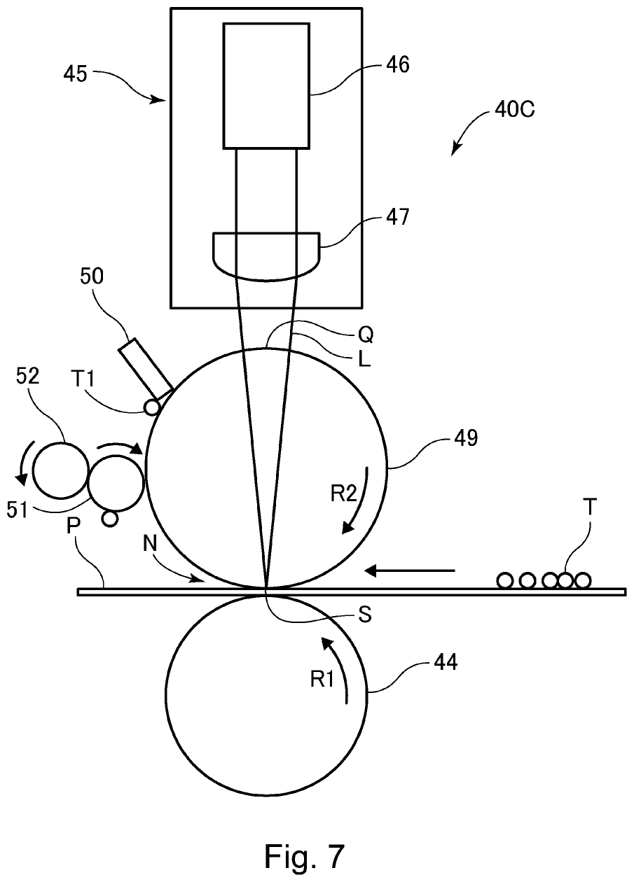

Third Embodiment will be described using FIG. 7. In the above-described First and Second Embodiments, the blade 50 or the fur brush 51 was used as the cleaning member, but in this embodiment, the surface of the contact member 49 is cleaned by two contact members. Other constitutions and actions are similar to those in First Embodiment. For this reason, in the following, constitutions similar to those in First and Second Embodiments will be omitted from description or briefly described by adding the same reference numerals or symbols, and a portion different from First and Second Embodiments will be principally described.

As described above, with reference to FIG. 6, the blade 50 is high in toner removal accuracy but is poor in durability of the contact member 49. On the other hand, the fur brush 51 is low in toner removal accuracy but is good in durability of the contact member 49. For this reason, a fixing device 40C of this embodiment includes the blade 50 as the cleaning member and the fur brush 51 as another cleaning member. That is, each of the blade 50 and the fur brush 51 is provided in a position, of the surface of the contact member 49, where the laser emitted from the laser light irradiation portion 45 is not blocked, and thus cleans the surface of the contact member 49.

These blade 50 and fur brush 51 are disposed at different positions with respect to the rotational direction of the contact member 49. Specifically, the blade 50 and the fur brush 51 clean the surface of the contact member 49 at positions located downstream of the nip N and upstream of the incident position Q with respect to the rotational direction of the contact member 49. Particularly, in this embodiment, the fur brush 51 contacts the contact member 49 at the position located downstream of the nip N and upstream of the contact position between the blade 50 and the contact member 49 with respect to the rotational direction of the contact member 49.

By employing such a constitution, the offset toner T1 offset to the contact member 49 in the nip N is carried by the contact member 49 in a fixed state. Thereafter, the offset toner T1 is scraped off by the fur brush 51 to some extent. A part of the toner scraped off is carried by a toner feeding member 52 to an unshown residual toner collecting box, and the remaining part of the toner is returned to the fur brush 51.

The toner returned to the fur brush 51 and the toner passed through the fur brush 51 are carried to the downstream blade 50. The toner reaching the blade 50 is divided into a portion which is scraped off from the surface of the contact member 49 and which enters the unshown residual toner box, a portion which is scraped off from the surface of the contact member 49 and which drops on the fur brush 51, and a portion which is scraped off from the surface of the contact member 49 and which is deposited again on the surface of the contact member 49. The toner dropped on the fur brush 51 is carried to the residual toner collecting box or is returned to the fur brush 51 as described above, and the toner deposited again on the surface of the contact member 49 is scraped off again by the blade 50.

Here, the toner reaching the blade 50 is weakened in electrostatic or non-electrostatic depositing force between itself and the contact member 49 by contact with the fur brush 51. For this reason, the toner can be sufficiently scraped off even when the contact pressure of the blade 50 to the contact member 49 is made smaller than the contact pressure in the case where the toner is removed only by the blade 50 as in First Embodiment. For this reason, in this embodiment, the contact pressure of the blade 50 to the contact member 49 is made 10 N/m or less. As a result, compared with First Embodiment, damage on the surface of the contact member 49 by the blade 50 can be reduced, so that the durability of the contact member 49 can be enhanced. However, the contact pressure of the blade 50 to the contact member 49 may preferably be 3 N/m or more, more preferably be 5 N/m or more.

In the case of this embodiment as described above, the contact member 49 is cleaned by the blade 50 and the fur brush 51, and therefore, not only the offset toner deposited on the contact member 49 can be sufficiently removed, but also the durability of the contact member 49 can be enhanced. That is, with respect to the rotational direction of the contact member 49, the surface of the contact member 49 is cleaned by the fur brush 51 at the position upstream of the blade 50, and therefore, the contact pressure of the blade 50 to the contact member 49 can be decreased. Further, as described above with reference to FIG. 6, in the case of the fur brush 51, damage on the contact member 49 is small. For this reason, as shown in FIG. 6, in the case of this embodiment (blade+fur brush), the durability of the contact member 49 can be enhanced compared with First Embodiment. Further, the surface of the contact member 49 is cleaned by the fur brush 51 and the blade 50, and therefore, the toner removal accuracy can also be made higher than those in the constitutions other than the constitution of FIG. 6.

Incidentally, a combination of a plurality of cleaning members may be any combination of the blade, the fur brush, the air blowing constitution and the web. For example, the blade may be combined with the air blowing constitution or the web, and the fur brush may also be combined with the air blowing constitution or the web. Further, three or more cleaning members may also be combined with each other.

Further, arrangement of the plurality of the cleaning members may preferably be downstream of the nip N and upstream of the incident position Q, but may also be upstream of the nip N and downstream of the incident position Q. Further, the order of the arrangement of the plurality of the cleaning members may be appropriately be set, but the cleaning member high in toner removal accuracy may preferably be disposed downstream of the remaining member(s) with respect to the rotational direction of the contact member 49.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2018-162157 filed on Aug. 30, 2018, which is hereby incorporated by reference herein in its entirety.

What is claimed is:

1. An image heating apparatus for heating an image on a recording material with laser light, said image heating apparatus comprising:
a first rotatable member through which the laser light passes and which is contactable to the image on the recording material;
a second rotatable member pressing said first rotatable member to form a nip in which the recording material is nipped and fed;
a laser light irradiation portion provided outside said first rotatable member and configured to irradiate the nip with the laser light by emitting the laser light so as to enter said first rotatable member from the outside of said first rotatable member; and
a cleaning member configured to clean said first rotatable member in contact with a surface of said first rotatable member,
wherein said cleaning member is provided in a position other than a position where the laser light emitted from said laser light irradiation portion toward the nip is blocked.

2. An image heating apparatus according to claim 1, wherein said first rotatable member is formed with a cylindrical glass member.

3. An image heating apparatus according to claim 2, wherein said first rotatable member includes a transparent rubber layer and a transparent fluorine-containing layer on the glass member.

4. An image heating apparatus according to claim 1, wherein with respect to a rotational direction of said first rotatable member, said cleaning member is disposed on a side upstream of a position where the laser light entering said first rotatable member and said first rotatable member cross each other and downstream of the nip.

5. An image heating apparatus according to claim 1, wherein said cleaning member is a blade member.

6. An image heating apparatus according to claim 1, wherein said cleaning member is a fur brush.

7. An image heating apparatus according to claim 1, wherein a contact pressure of said blade member to said first rotatable member is 12.3 N/m or more and 43 N/m or less.

8. An image heating apparatus according to claim 1, wherein said cleaning member includes a plurality of cleaning members contacting said first rotatable member.

9. An image heating apparatus according to claim 8, wherein said plurality of cleaning members include a fur brush and a blade member, and wherein with respect to a rotational direction of said first rotatable member, said fur brush is provided in contact with said first rotatable member on a side downstream of the nip, and said blade member is provided on a side downstream of said fur brush and upstream of a position where the laser light entering said first rotatable member and said first rotatable member cross each other.

10. An image heating apparatus according to claim 1, wherein said laser light irradiation portion includes a laser emitting portion configured to emit the laser light and a lens configured to concentrate the laser light.
